(19) United States
(12) Patent Application Publication
(10) Pub. No.: US 2022/0212711 A1
(43) Pub. Date: Jul. 7, 2022

(54) HEATING STRUCTURE AND STEERING WHEEL

(71) Applicant: LANGFANG GOLDEN TIME TECHNOLOGY DEVELOPMENT CO., LTD., Langfang, Hebei (CN)

(72) Inventors: Haitao ZHANG, Langfang (CN); Chunmei LI, Langfang (CN); Lihua FAN, Langfang (CN)

(73) Assignee: LANGFANG GOLDEN TIME TECHNOLOGY DEVELOPMENT CO., LTD., Langfang, Hebei (CN)

(21) Appl. No.: 17/277,221

(22) PCT Filed: Jul. 24, 2020
(86) PCT No.: PCT/CN2020/104037

§ 371 Date: Mar. 17, 2021

(30) Foreign Application Priority Data
Sep. 19, 2019 (CN) 201910888727.0
Sep. 19, 2019 (CN) 201910888730.2

(51) Int. Cl. B62D 1/06; H05B 3/06

(52) U.S. Cl. CPC B62D 1/065; H05B 2203/014; H05B 3/06

(57) ABSTRACT

Provided are a heating structure and a steering wheel including the heating structure. The heating structure includes a substrate layer and a heating wire paved fixedly to the substrate layer by an adhesive. The heating wire is provided with multiple bent portions. The bent portions is in a shape formed by squeezing and bending the heating wire. The heating structure is configured to be arranged between a rim and an outer skin of a steering wheel. The heating structure is simpler in processing process, results in a higher yield and has a better heating effect. No scratches and visible veins will be created on the surface of the steering wheel, so that the product has an improved appearance.

### CROSS-REFERENCE TO RELATED APPLICATIONS

The present disclosure claims priority to Chinese Patent Application No. 201910888730.2, filed with the Chinese Patent Office on Sep. 19, 2019, entitled “Heating Structure and Steering Wheel”, and Chinese Patent Application No. 201910888727.0, filed with the Chinese Patent Office on Sep. 19, 2019, entitled “Heating Structure and Steering Wheel”, which are incorporated herein by reference in their entireties.

### TECHNICAL FIELD

The present disclosure relates to the technical field of automobile parts, and in particular to a heating structure and a steering wheel.

### BACKGROUND ART

In the case of a relatively low ambient temperature, a cold steering wheel will make an operator's hands feel very uncomfortable when the operator is controlling the direction of travel of a device. In a severe case, the operator's hands may become stiff and thus may not respond in time to cause an unnecessary disaster. Therefore, in order to improve the comfort of the steering wheel, reduce the occurrence of disasters, and meet the current market demand, there is an increasingly extensive demand on the market for a heating device equipped on a steering wheel for controlling the direction of travel of a device.

The current heating structures on steering wheels have low processing efficiency and a high rejection rate. Moreover, the prior art heating structures of the steering wheels have an unsightly appearance.

### SUMMARY

An object of the present disclosure includes, for example, providing a heating device and a steering wheel, by which at least one of the technical problems existing in the prior art can be ameliorated. The heating structure can be produced with increased efficiency and have a more ornamental appearance.

Embodiments of the present disclosure are implemented as follows.

In a first aspect, the present disclosure provides a heating structure, comprising a substrate layer, further comprising: a heating wire paved fixedly to the substrate layer by an adhesive. The heating wire is provided with multiple bent portions. The bent portions is in a shape formed by squeezing and bending the heating wire. The heating structure is configured to be arranged between a rim and an outer skin of a steering wheel.

Optionally, the shape of the bent portion is any one of a sawtooth shape, a triangle shape, a V shape, a U shape, a square shape, an S shape, and a trapezoid shape.

Optionally, the heating wire is in a meandering shape in its extending direction.

Optionally, an adhesive layer is disposed on either single side of the substrate layer, or adhesive layers are disposed on both sides of the substrate layer.

The heating wire is glued and fixed to the substrate layer by means of the adhesive layer.

Optionally, the adhesive layer is formed integrally with the substrate layer, or the adhesive layer is applied to the substrate layer.

Optionally, the adhesive layer is an adhesive film.

Optionally, the heating structure further includes a release paper which is removably disposed on a side of the at least one adhesive layer facing away from the substrate layer.

Optionally, the adhesive for fixing the heating wire is distributed as scattered dots between the heating wire and the substrate layer to form adhesive dot layers, or is wrapped around at least part of an outer surface of the heating wire to form an adhesive wrapping layer.

Optionally, the adhesive is made of any one of a non-setting adhesive, a hot melt adhesive, a UV adhesive, and a self-setting adhesive.

Optionally, a flexible layer is further disposed on a side of the substrate layer where the heating wire is adhered.

Optionally, the flexible layer is made of at least one of non-woven fabric, gauze, leather, leatherette, a foam pad, a plastic film, high-elastic sponge, EPDM, and PVC.

Optionally, a hands-off detection device is disposed on a side of the substrate layer where the heating wire is not disposed.

Optionally, the hands-off detection device includes a spacer layer and a sensing layer. The spacer layer is disposed adjacent to the substrate layer. The sensing layer is provided with at least one sensing region.

Optionally, the hands-off detection device further includes a shielding layer which is disposed on a side of the spacer layer away from the sensing layer.

Optionally, the sensing layer is provided with two sensing regions, wherein a first sensing region of the two sensing regions and a second sensing region of the two sensing regions are disposed on left and right sides of the steering wheel, respectively.

Alternatively, the sensing layer is provided with three sensing regions, wherein a first sensing region and a second sensing region of the three sensing regions are configured to be disposed on a front side of the steering wheel, and a third sensing region of the three sensing regions is configured to be disposed on a back side of the steering wheel.

Optionally, a flexible layer is disposed on the side of the substrate layer where the hands-off detection device is disposed.

In a second aspect, an embodiment of the present disclosure provides a steering wheel. The steering wheel has a rim clad with any heating structure described above.

Optionally, an outer surface of the heating structure is wrapped with a cladding layer.

Optionally, the cladding layer is an outer skin.

In the present disclosure, optionally, a foamed structure is further disposed between the heating structure and the cladding layer.

Compared with the prior art, the embodiments of the present disclosure include, for example, the following advantageous effects.

In summary, in the present disclosure, the heating wire is fixed to the substrate layer by using an adhesive. This processing process is simpler and results in a higher yield than the sewing method in the prior art. According to the technical solution according to an embodiment of the present disclosure, the heating wire is provided with multiple bent portions. For example, when the heating wire is a heating resistance wire, the design of the resistance wire with bent portions increases the length of the resistance laid per unit area, namely, lengthens the length of the resistance laid on the substrate layer, so that the heating structure has a better heating effect. Moreover, the above-mentioned bent portions may be obtained by being squeezed or pressed by a mechanical device. As compared with the processing method of sewing a heating pad with a winding thread commonly used in the prior art, the above-mentioned heating structure according to the present disclosure can be further improved in terms of processing efficiency and allows heat generated by heating to be dissipated more uniformly because the patterns squeezed by the mechanical device are more uniform than the patterns formed by sewing. In addition, the heating structure and the steering wheel according to the present disclosure have better stretchability than sewed products because they are not fixed and restricted by sewing threads. Furthermore, after the steering wheel is clad with the heating structure fabricated without a sewing process, no scratches and visible veins will be created on the surface of the steering wheel, so that the appearance of the steering wheel product can be further improved, and the steering wheel can provide an improved grip feeling.

The heating structure and the steering wheel according to the present disclosure are further provided with a hands-off detection device, so that the heating structure and the steering wheel have both heating and hands-off detection functions. In this way, the steering wheel can be produced and manufactured with reduced processing and labor costs, and the steering wheel can be produced and manufactured with increased efficiency.

In addition, the present disclosure provides hands-off detection functions in multiple regions, which can be respectively used for identifying: a state where the steering wheel is held with one hand, a state where the steering wheel is held with both hands, and a posture in which the steering wheel is gripped with both hands. The operating posture of the driver during driving can be better identified so as to promptly remind the driver to maintain the correct gripping posture at all times. This provides further safety guarantee for traffic safety.

In addition to the technical problems solved by the present disclosure, the technical features constituting the technical solutions, and the advantages achieved by the technical features of these technical solutions as described above, other technical problems that can be solved by the heating structure and the steering wheel according to the present disclosure, other technical features included in the technical solutions, and the advantages achieved by these technical features will be described in further detail with reference to the accompanying drawings.

### BRIEF DESCRIPTION OF THE DRAWINGS

Other features, objects, and advantages of the present disclosure will become more apparent by reading the detailed description of non-limiting embodiments with reference to the following drawings.

FIG. 1 is a schematic structural view of a heating structure of the present disclosure;

FIG. 2 is a schematic sectional structural view taken along a direction A-A in FIG. 1,

FIG. 3 is a schematic structural view of a first modified structure of an adhesive layer of the present disclosure;

FIG. 4 is a schematic structural view of a second modified structure of the adhesive layer of the present disclosure;

FIG. 5 is a schematic structural view of a heating wire of the present disclosure;

FIG. 6 is a schematic structural view of a first modified structure of the heating wire of the present disclosure;

FIG. 7 is a schematic structural view of a second modified structure of the heating wire of the present disclosure;

FIG. 8 is a schematic structural view of a third modified structure of the heating wire of the present disclosure;

FIG. 9 is a schematic structural view of a first modified structure of the heating structure of the present disclosure;

FIG. 10 is a schematic structural view of a second modified structure of the heating structure of the present disclosure (with a single-sided adhesive layer);

FIG. 11 is a schematic structural view of a third modified structure of the heating structure of the present disclosure (with a double-sided adhesive layer);

FIG. 12 is a schematic structural view of a fourth modified structure of the heating structure of the present disclosure;

FIG. 13 is a schematic structural view of a fifth modified structure of the heating structure of the present disclosure;

FIG. 14 is a schematic structural view of a sixth modified structure of the heating structure of the present disclosure;

FIG. 15 is a schematic structural view of a seventh modified structure of the heating structure of the present disclosure;

FIG. 16 is a schematic structural view of a steering wheel of the present disclosure;

FIG. 17 is a schematic sectional structural view taken along a direction B-B in FIG. 16 of the present disclosure;

FIG. 18 is a schematic structural view of a steering wheel formed after single foaming in the present disclosure;

FIG. 19 is a schematic structural view of a steering wheel obtained by using an integrated foaming process in the present disclosure;

FIG. 20 is a schematic structural view of a first modified structure of the steering wheel of the present disclosure;

FIG. 21 is a front-side sectional structural view of a steering wheel manufactured by single foaming and provided with one sensing region according to the present disclosure;

FIG. 22 is a front-side sectional structural view of a steering wheel manufactured by single foaming and provided with two sensing regions according to the present disclosure, and is also a front-side sectional structural view of a steering wheel manufactured by single foaming and provided with three sensing regions;

FIG. 23 is a back-side sectional structural view of a steering wheel manufactured by single foaming and provided with three sensing regions according to the present disclosure;

FIG. 24 is a front-side sectional structural view of a steering wheel manufactured by dual foaming and provided with one sensing region according to the present disclosure;

FIG. 25 is a front-side sectional structural view of a steering wheel manufactured by dual foaming and provided with two sensing regions according to the present disclosure, and is also a front-side sectional structural view of a steering wheel manufactured by dual foaming and provided with three sensing regions; and

FIG. 26 is a back-side sectional structural view of a steering wheel manufactured by dual foaming and provided with three sensing regions according to the present disclosure.

Reference Numerals in the Figures: 100-heating structure; 110-substrate layer; 111-adhesive film; 112-release paper; 120-heating wire; 130-flexible layer; 140-adhesive; 141-adhesive layer; 142-adhesive dot layer; 143-adhesive wrapping layer; 150-shielding layer; 160-spacer layer; 170-sensing layer; 171-first sensing region; 172-second sensing region; 173-third sensing region; 180-bonding part; 200-steering wheel; 210-rim; 220-spoke; 230-cladding layer; 240-foamed structure.

### DETAILED DESCRIPTION OF THE EMBODIMENTS

The present disclosure will be described in further detail below with reference to the accompanying drawings and embodiments. It will be understood that specific embodiments described here are only intended to explain a relevant invention, but not intended to limit the invention. In addition, it should be noted that only the parts related to the relevant invention are shown in the drawings for ease of description.

It should be noted that the embodiments in the present disclosure and the features in the embodiments may be combined with each other without conflict. The present disclosure will be described below in detail with reference to the accompanying drawings and in connection with embodiments.

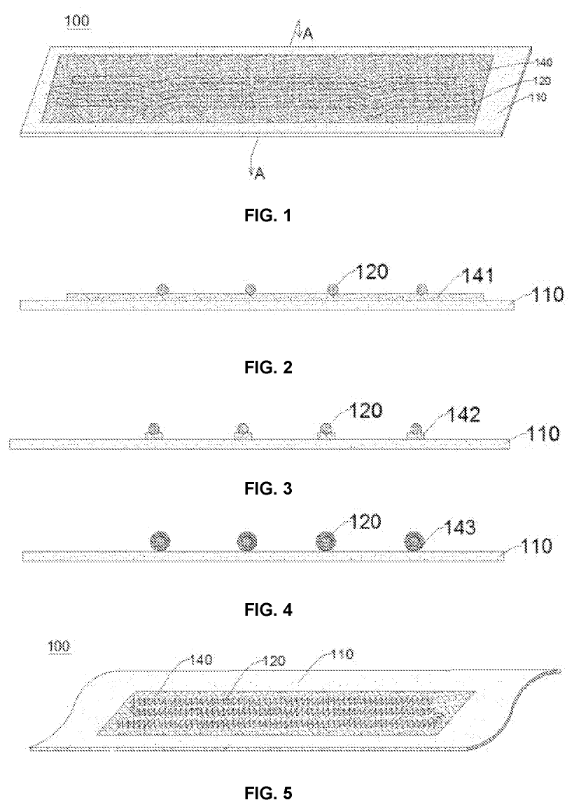

Referring to FIG. 1, FIG. 1 is a schematic structural view of a heating structure 100 according to the present disclosure, including a substrate layer 110 and a heating wire 120 paved fixedly to the substrate layer 110 by means of an adhesive 140. The heating structure 100 is configured to be arranged between the rim and the outer skin of a steering wheel.

Here, the substrate layer 110 may be made of a material with mesh characteristics, including, but not limited to, at least one of a woven fabric and a non-woven material. The substrate layer 110 may be composed of two or more composite materials.

Optionally, the adhesion between the substrate layer 110 and the heating wire 120, namely, the implementation of the adhesive 140 includes, but not limited to, the following several modes.

1. Adhesive Layer Mode. In other words, the adhesive 140 covers the entire surface of the substrate layer 110 to form an adhesive layer 141. Optionally, the implementation of the adhesive layer 141 includes, for example, the following methods.
(a) As shown in FIG. 2, the adhesive layer 141 is provided as an adhesive film covering either single side of the substrate layer 110, and the adhesive layer 141 and the substrate layer 110 are formed as an integral structure. It will be understood that the integral structure formed by the adhesive layer 141 together with the substrate layer 110 is in the form of a single-sided adhesive, for example, a single-sided adhesive tape with a cotton substrate or a meshed substrate. The adhesive film is configured to have an adhesion surface to which the heating wire 120 is adhered and which faces away from the substrate layer 110.
(b) Referring to FIG. 11, the adhesive layers 141 are disposed to cover both sides of the substrate layer 110, and the adhesive layers 141 and the substrate layer 110 are formed as an integral structure. It will be understood that the integral structure formed by the adhesive layers 141 together with the substrate layer 110 is in the form of a double-sided adhesive, for example, a double-sided adhesive tape with a cotton substrate or a meshed substrate. Referring to FIG. 11, in this case, the adhesive layers 141 are provided as adhesive films 111 covering both sides of the substrate layer 110. The adhesive films 111 are disposed on both sides of the substrate layer 110 opposite to each other. The adhesive film 111 is configured to have an adhesion surface to which the heating wire 120 is adhered and which faces away from the substrate layer 110. The heating wire 120 may be disposed on either side of the substrate layer 110 and adhered to the corresponding adhesive film 111.
(c) A non-setting adhesive, a hot melt adhesive, a UV adhesive, or a self-setting adhesive is applied to the entire surface of the substrate layer 110, that is, formed on the substrate layer 110 later.

The arrangement of the adhesive layer 141 enables a protective structure to be conveniently pasted to the outer side of the heating structure 100.

2. Adhesive Dot Layer Mode. As shown in FIG. 3, the adhesive 140 is distributed as scattered dots between the substrate layer 110 and the heating wire 120 to form adhesive dot layers 142.

It should be noted that each adhesive dot layer 142 may have a structure in the shape of a strip, a block, or a strip combined with a block. Furthermore, when the adhesive dot layer 142 is in a strip shape, a plurality of adhesive dot layers 142 may extend in the same direction and be arranged uniformly at intervals in another direction perpendicular to the extending direction.

3. Adhesive Wrapping Form. As shown in FIG. 4, the adhesive 140 is wrapped around the entire surface or partial surface of the heating wire 120 to form an adhesive wrapping layer 143.

Optionally, the adhesive wrapping layer 143 is wrapped around the entire outer peripheral surface of the heating wire 120. In other words, the adhesive wrapping layer 143 has a cross section shaped as an annular structure in which the heater wire 120 is sheathed. Moreover, the adhesive wrapping layer 143 extends in a direction in which the heating wire 120 extends.

Optionally, the adhesive 140 may be made of any one of a non-setting adhesive, a hot-melt adhesive, a UV adhesive, and a self-setting adhesive.

Here, in the present disclosure, the heating wire 120 is a resistance wire for heating the rim of a steering wheel. In the prior art, a heating structure 100 for a steering wheel includes a substrate layer and a heating wire (a resistance wire) sewn on the substrate layer, wherein the resistance wire is sewn on the substrate layer in a set shape. In the present disclosure, the heating wire 120 is wound straightly and glued and fixed to the substrate layer 110 by means of an adhesive 140. Such operation is performed simply at a low error rate. The heating wire 120 is more easily distributed on the substrate layer 110 in a uniformly spaced manner, so that all portions of the rim of the steering wheel can be heated more uniformly during use, whereby the driver will feel more comfortable when gripping the steering wheel.

In addition, in the present disclosure, when the heating structure 100 is formed into a single product by using the adhesive layer 141 as the adhesive 140, a release paper 112 is laid on a side of the substrate layer 110 where the adhesive layer 141 is disposed. The release paper 112 is adhered to a side of the adhesive layer 141 facing away from the substrate layer 110 and can cover the heating wire 120. When the heating structure 100 is not used, the release paper 112 may be kept in a state of being pasted to the adhesive layer 141 to prevent contamination of the adhesive layer 141 and the heating wire 120. Moreover, when it is necessary to use the heating structure 100, the release paper 112 may be peeled off so that the heating structure can be pasted to a product to which it is to be applied. Such operation is convenient.

It should be noted that in each schematic view of the heating structure 100 according to the present disclosure, the relative position of the heating wire 120 and the adhesive 140 is not limited to the position shown in the figure. In other words, either a heating wire 120 adjacent to the substrate layer 110, or an adhesive 140 adjacent to the substrate layer 110 is within the scope of protection of the technical solution of the present disclosure.

In the present disclosure, optionally, the shape of the bent portions of the heating wire 120 is formed by squeezing and bending the heating wire 120. The heating wire is provided with multiple bent portions.

Optionally, the heating wire 120 includes a plurality of sub-units. Each of the sub-units includes multiple continuous bent portions. The plurality of sub-units are arranged in parallel and spaced apart from one another. The plurality of sub-units are connected sequentially in an end-to-end manner. In other words, the heating wire 120 is in a meandering shape in its extending direction.

As shown in FIG. 5, optionally, the heating wire 120 includes a number of continuous saw-toothed bent portions.

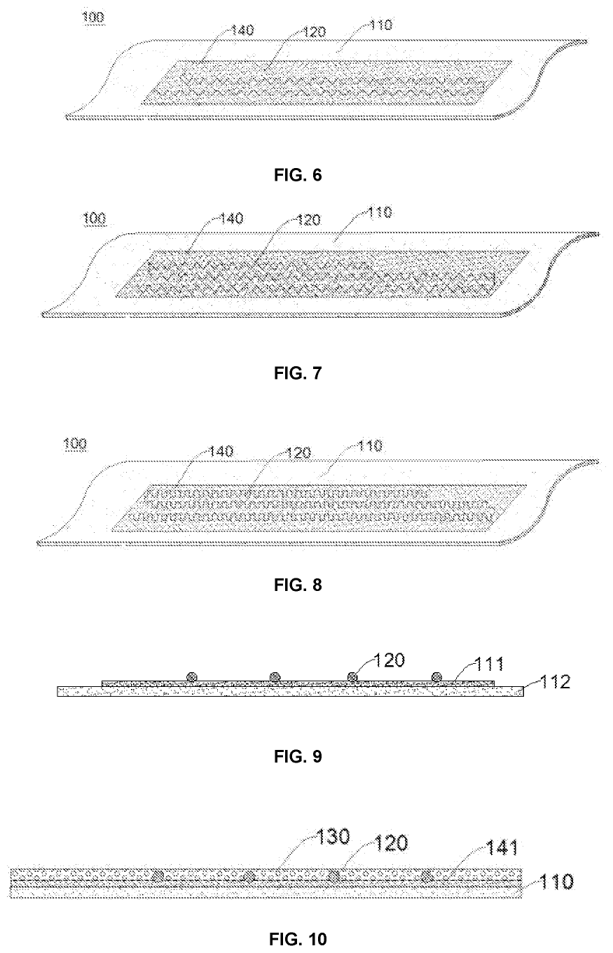

As shown in FIG. 6, optionally, the heating wire 120 includes a number of continuous trapezoidal bent portions.

As shown in FIG. 7, optionally, the heating wire 120 may include a number of continuous triangular bent portions.

As shown in FIG. 8, optionally, the heating wire 120 may include a number of continuous square bent portions.

It should be noted that the above-mentioned heating wires 120 with different bending shapes can be realized by being squeezed by mechanical devices with different shapes and structures and can be easily produced on a large scale by means of an assembly line. The fabricating process involved is simpler than a method in which a curved heating wire is obtained by sewing the heating wire on a heating pad substrate, so that the heating structure of the steering wheel can be produced with further increased efficiency.

In addition, in the present disclosure, the shape of the bent portions may be a U shape or other shape. As the heating wire 120 is designed as a bent structure, a longer heating wire 120 can be attached to unit area of the substrate layer 110, whereby the heating effect of the heating structure 100 is improved. More uniform heat is conducted from the uniformly squeezed patterns to the outer edge of the steering wheel, so that a better gripping experience can be obtained when the driver is gripping the steering wheel by hands.

As shown in FIG. 9, in the present disclosure, the adhesive 140 is an adhesive film 111. The heating wire 120 provided with multiple bent portions made by squeezing is attached to the adhesive film 111 of the release paper 112. When a steering wheel is being manufactured, the release paper 112 to which the heating wire 120 is attached is attached directly to the rim of the steering wheel. When the upper surface of the heating wire 120 is to be further equipped with other structural layers, further assembly can be performed by only peeling the release paper 112 off the adhesive film 111. In other words, the heating structure 100 includes a release paper 112 attached with an adhesive film 111 and a heating wire 120 glued to the adhesive film 111. The heating wire 120 is provided with multiple bent portions. The shape of the bent portions is formed by squeezing and bending the heating wire. In the present disclosure, optionally, the substrate layer 110 is provided as an adhesive film 111 to which a tear-off release paper 112 is attached. It should be noted that when the above-mentioned structure is to be packaged and transported, it is only necessary to attach, to the side where the heating wire 120 is pasted, a further layer of release paper to cover the exposed portions of the adhesive film 111 and the heating wire 120, thereby avoiding contamination of the adhesive film 111 and the heating wire 120. In addition, in the above-mentioned structure, no matter from which side the adhesive film 111 to which the heating wire 120 is attached is applied and attached to the rim of the steering wheel, the technical effect of firmly adhering the heating wire to the rim of the steering wheel can be obtained. Therefore, adhesion of either side of the above-mentioned adhesive film 111 to the rim of the steering wheel is claimed in the present disclosure.

In the present disclosure, when the release paper 112 attached with the adhesive film 111 is directly used as a finished product, there is no need to use the adhesive 140 separately in production, whereby the heating structure can be produced by a further simplified process with reduced production cost.

As shown in FIGS. 10 and 11, optionally, a flexible layer 130 is further pasted to a side of the substrate layer 110 where the heating wire 120 is disposed. Here, FIG. 10 corresponds to a mode where the adhesive layer 141 is disposed on a single side of the substrate layer 110, and FIG. 11 corresponds to a mode where the adhesive layers 141 are disposed on both sides of the substrate layer 110.

Optionally, a release paper 112 is disposed on the outer side of the adhesive layer 141 of the substrate layer 110 on which no heating wire 120 is disposed.

Optionally, an adhesive film may be used as the adhesive layer 141 disposed on one or both sides of the substrate layer 110.

Optionally, the material of the flexible layer 130 includes, but is not limited to, any one or two or more flexible materials selected from non-woven fabric, gauze, leather, leatherette, a foam pad, a plastic film, high-elastic sponge, EPDM, and PVC, wherein EPDM is an ethylene-propylene-diene monomer rubber, and PVC is made from a vinyl chloride monomer. On the one hand, the arrangement of the flexible layer 130 can avoid adverse effects on the comfort in gripping the steering wheel caused by the protruding portions of the heating wire 120. On the other hand, it can avoid damage of the heating wire 120 due to an external force and serve as a protector for the heating wire 120.

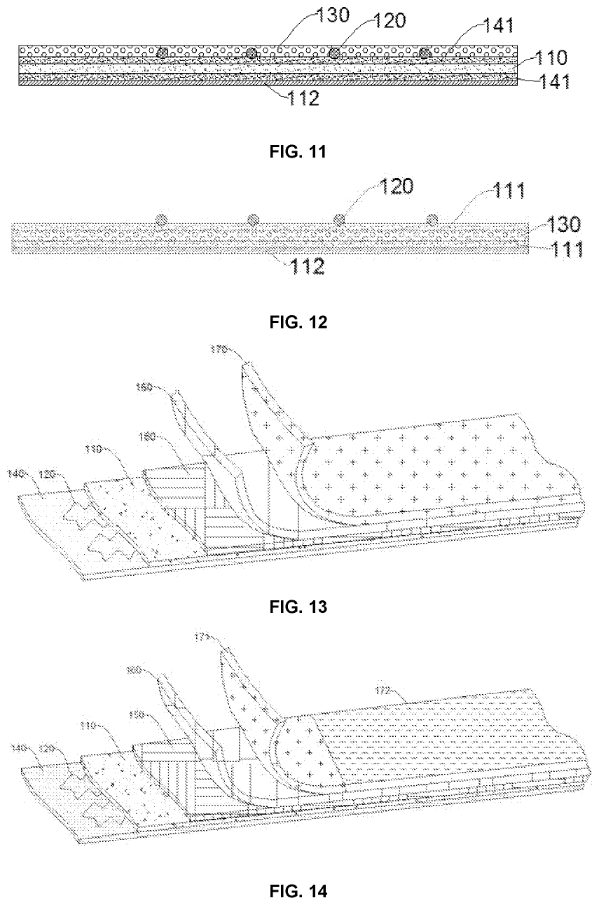

As shown in FIG. 12, optionally, the substrate layer 110 is provided as a flexible layer 130 having both sides provided with adhesive films 111, respectively. The adhesive films 111 on both sides comprise an adhesive film 111 on one side to which the heating wire 120 is adhered, and an adhesive film 111 on the other side to which no heating wire 120 is adhered and to which a release paper 112 is adhered. If the above-mentioned structure is to be packaged and transported, it is only necessary to attach, to the side where the heating wire 120 is attached, a further layer of release paper 112 to cover the exposed portions of the adhesive film 111 and the heating wire 120 with the release paper 112, thereby avoiding contamination of the adhesive film 111 and the heating wire 120.

In the present disclosure, the flexible layer 130 is directly used as the substrate layer 110. This avoids adverse effects on the comfort in gripping the steering wheel caused by the protruding portions of the heating wire 120. Moreover, the structural layers of the heating structure are simplified, the cost is reduced, and the process steps are simplified.

As shown in FIG. 13, optionally, a hands-off detection device is fixedly disposed on a side of the substrate layer 110 where no heating wire 120 is disposed. The hands-off detection device includes a shielding layer 150, a spacer layer 160, and a sensing layer 170 arranged in sequence, wherein the shielding layer 150 is adjacent to the substrate layer 110. Optionally, the shielding layer 150, the spacer layer 160, and the sensing layer 170 are arranged sequentially in a stack manner. In the present disclosure, optionally, the shielding layer 150 is made of a metal material, for example, formed from a metal coating or a metal conducting wire, for isolating a signal of the heating wire 120 from a signal of the sensing layer 170, so that the signal of the heating wire 120 and the signal of the sensing layer 170 will not interfere with each other. The spacer layer 160 is made of an insulating material. In the present disclosure, the sensing layer 170 is a complete sensing region.

In the present disclosure, a hands-off detection device is disposed on the side of the substrate layer 110 where no heating wire 120 is disposed, so that the heating structure 100 not only has a heating function, but also has a hands-off detection function. When the two functional structures are integrated, both of the important functions of heating and hands-off detection can be implemented in the same product. In this way, a steering wheel can be produced and manufactured by a simplified process, thereby further increasing the production efficiency of a steering wheel manufacturer.

As shown in FIG. 14, optionally, the sensing layer 170 is provided with two sensing regions, namely, a first sensing region 171 and a second sensing region 172. The two sensing regions are configured to sense the states of gripping of different positions of the steering wheel by the driver, respectively. The dual sensing regions are provided such that not only it can be detected whether the driver is driving in a hands-off state, but also it can be further detected whether the driver is holding the steering wheel with one hand during driving.

Optionally, the first sensing region 171 is configured to detect whether the driver's left hand is taken off the steering wheel, and the second sensing region 172 is configured to detect whether the driver's right hand is taken off the steering wheel. When the heating structure 100 is mounted around the rim of the steering wheel, the first sensing region 171 fully covers the range of a region that is often gripped by the left hand when the driver is driving while holding the steering wheel with hands in a correct posture according to traffic rules, and the second sensing region 172 fully covers the range of a region that is often gripped by the right hand when the driver is driving while holding the steering wheel with hands in a correct posture according to traffic rules.

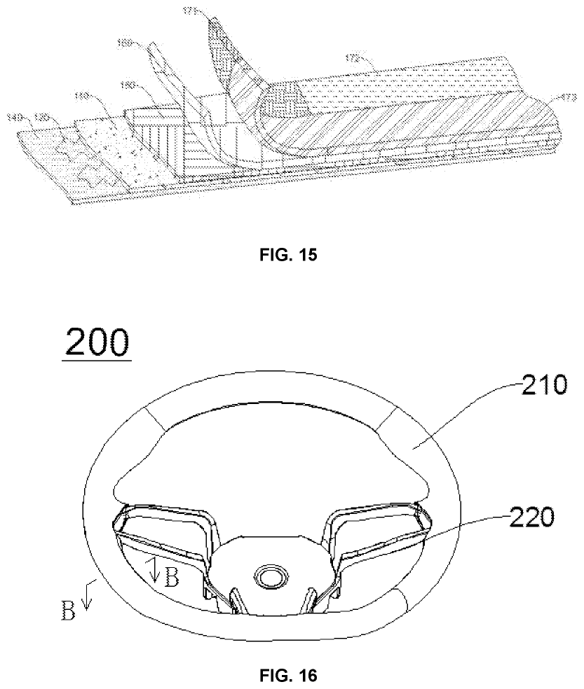

As shown in FIG. 15, optionally, the sensing layer 170 is provided with three sensing regions, namely, a first sensing region 171, a second sensing region 172, and a third sensing region 173. Here, when the heating structure 100 is disposed around a steering wheel, the first sensing region 171 and the second sensing region 172 are located on a front side of the steering wheel. The front side of the steering wheel refers to a side of the steering wheel facing the driver. Moreover, the first sensing region 171 is located on the left side of the steering wheel when the driver faces the steering wheel. The second sensing region 172 is located on the right side of the steering wheel when the driver faces the steering wheel. The third sensing region 173 is configured to be disposed on a back side of the steering wheel. The back side of the steering wheel refers to a side of the steering wheel facing a dashboard.

In the present disclosure, the first sensing region 171 is configured to detect whether the driver's left hand is holding and resting on the upper surface of the steering wheel. The second sensing region 172 is configured to detect whether the driver's right hand is holding and resting on the upper surface of the steering wheel. The third sensing region 173 is clad on the back side of the rim of the steering wheel and configured to detect whether the steering wheel is gripped by the driver's hand(s) holding the steering wheel. It should be noted that the number of subregions provided in the sensing layer in the present disclosure is not limited to the case disclosed above. The sensing layer may be divided into a larger number of sensing regions to meet the requirement for more detailed detection, which is also claimed in the present disclosure.

In addition, the arrangement form of the sensing regions is not limited to the case disclosed above. Optionally, the third sensing region 173 may be divided into two regions, which are respectively used for identifying whether the steering wheel is gripped by the driver's left hand and whether the steering wheel is gripped by the driver's right hand.

In the present disclosure, optionally, a flexible layer is disposed on the side of the substrate layer 110 where the hands-off detection device is disposed, in order to improve the comfort of the driver in gripping the steering wheel.

Optionally, the flexible layer disposed on the side where the hands-off detection device is located may be in the same structure and made of the same material as the flexible layer disposed on the side where the heating wire 120 is located.

After the above-mentioned hands-off (HOD) identification means for steering wheel is used, the driver can be promptly reminded to hold the steering wheel with hands in a correct gripping posture. There is less occurrence of safety hazards such as accidents caused because the driver grips the steering wheel with only one hand or merely puts his or her hands on the upper surface of the steering wheel.

As shown in FIG. 16, here, the rim 210 refers to the outer ring part connected to the spoke 220 of the steering wheel 200. Optionally, sectional views take along a direction B shown in FIG. 16 are used as main views to explain different shapes formed by cladding the rim with different heating structures and the functions corresponding to the corresponding shapes and structures in use.

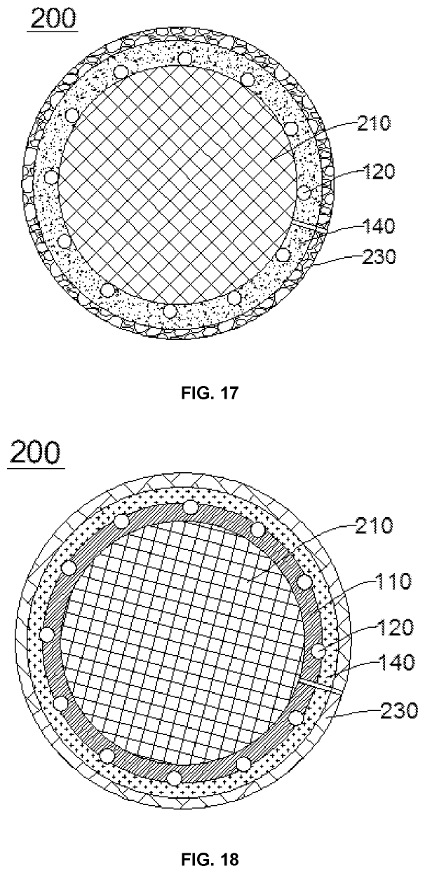

FIG. 17 shows a cross-sectional view of one of the steering wheels 200 when viewed from the direction B. The entire outer peripheral surface of the rim 210 of the steering wheel 200 is clad with a heating structure 100, wherein the surface of the rim 210 of the steering wheel is provided as the substrate layer of the heating structure, and the heating wire 120 is arranged directly on the surface of the rim 210 by means of the adhesive 140. Then a cladding layer is arranged on the outermost layer. The heating wire 120 is clad by the cladding layer. After the above-mentioned structure is used, the heating wire 120 will be distributed more uniformly, whereby a more comfortable grip feeling and heating effect can be achieved.

Optionally, in the structure shown in FIG. 17, the substrate layer 110 in the heating structure 100 may be replaced by the cladding layer 230 of the steering wheel 200.

FIG. 18 shows a steering wheel 200 according to the present disclosure. The steering wheel 200 is clad by a heating structure 100, and the heating structure 100 is further wrapped by a cladding layer 230. In the present disclosure, the cladding layer 230 is glued to the heating structure 100 and wrapped around the rim 210 together with the heating structure 100. Here, in the above-mentioned structure, the substrate layer 110 is in direct contact with the rim 210.

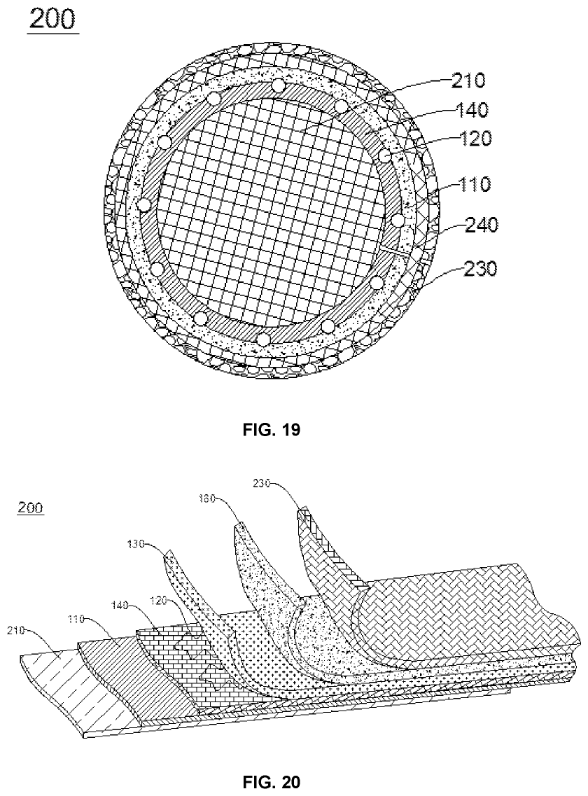

Optionally, as shown in FIG. 19, a steering wheel according to the present disclosure is clad by a heating structure 100, and the heating structure 100 is wrapped by a cladding layer 230. The substrate layer 110 is adjacent to the cladding layer 230 at its side remote from the heating wire 120, and a foamed structure 240 is disposed therebetween. The heating structure 100 is fixed around the rim 210 by means of the adhesive 140 on the substrate 110 and is foamed integrally with the steering wheel 200. The cladding layer 230 is wrapped around the outer side of the foamed structure 240 after the foaming.

In the present disclosure, the comfort of the steering wheel is further increased by the arrangement of the foamed structure 240.

As shown in FIG. 20, the rim 210 of a steering wheel according to this embodiment is clad by a heating structure 100, and the heating structure 100 is wrapped by a cladding layer 230. In the present disclosure, the heating structure 100 includes a flexible layer 130. The flexible layer 130 is disposed on a side of the substrate layer 110 where the heating wire 120 is disposed. The cladding layer 230 is connected to the flexible layer 130 by means of a bonding part 180. After the above-mentioned structure is used, the flexible layer 130 can weaken the slight discomfort in gripping caused by the protruding effect of the heating wire 120, so that the steering wheel can be gripped with better improved comfort.

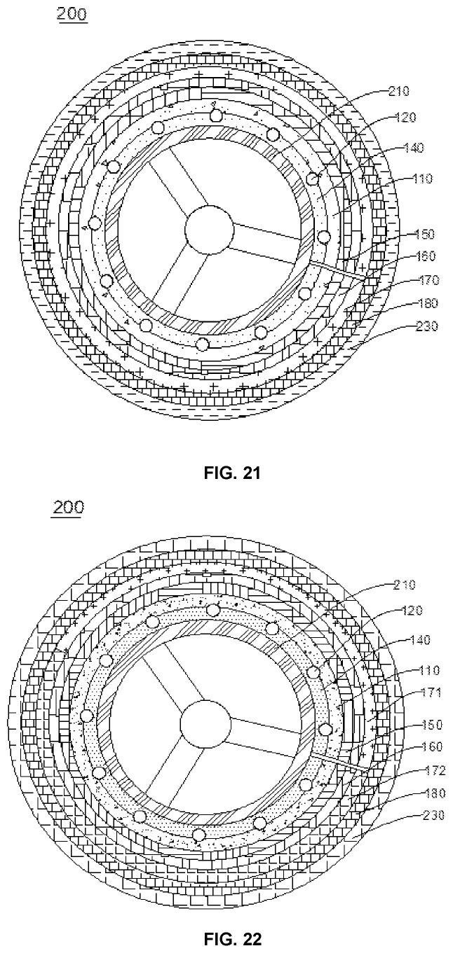

As shown in FIG. 21, a steering wheel according to the present disclosure is clad by a heating structure 100. The heating structure 100 includes a sensing region 150 disposed on a side of the substrate layer 110 where no heating wire 120 is disposed. A sensing layer 170 is disposed on the outer side of the sensing region 150 in such a manner that they are separated by a spacer layer 160, and the heating structure 100 is wrapped by a cladding layer 230. Optionally, the sensing layer 170 is connected to the cladding layer 230 by means of a bonding part 180.

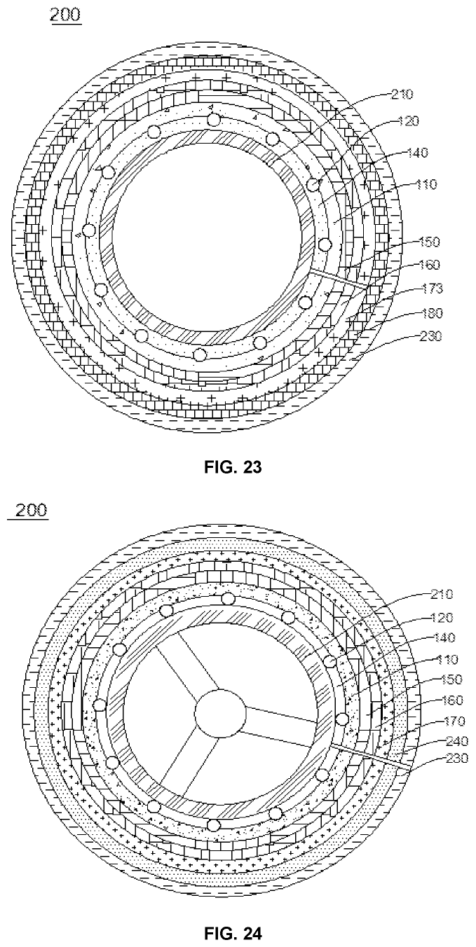

Optionally, as shown in FIG. 22, a heating structure 100 is mounted around the rim of a steering wheel 200, after single foaming. The sensing layer 170 is correspondingly provided with two sensing regions (a first sensing region 171 and a second sensing region 172), or the sensing layer 170 is provided with three sensing regions. Here, on the front side of the steering wheel, the first sensing region 171 and the second sensing region 172 are disposed at positions consistent with the positions at which the first sensing region 171 and the second sensing region 172 are disposed as shown in FIG. 14. Referring to FIG. 23, on the back side of the steering wheel, a third sensing region 173 is further disposed in the structural layer for providing the sensing regions.

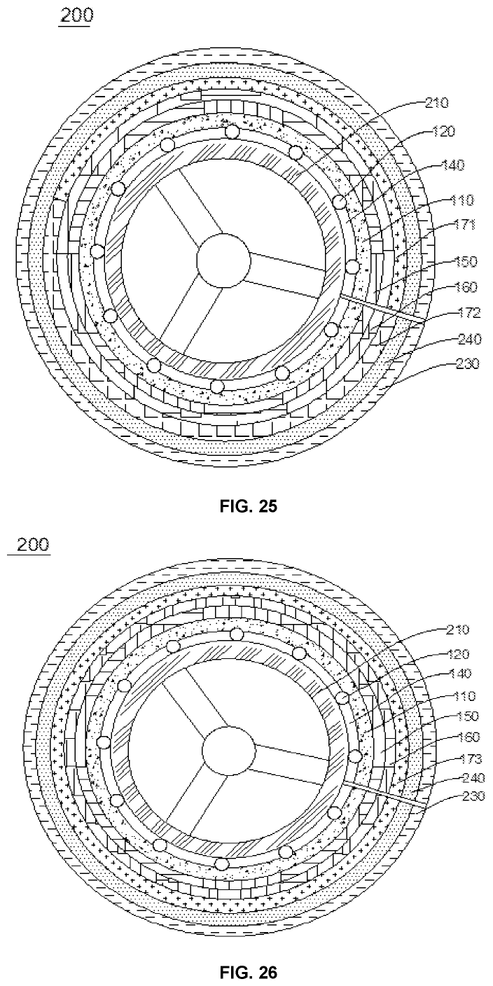

As shown in FIGS. 24 to 26, the rim 210 of a steering wheel, after dual foaming, is clad by a heating structure 100, and the heating structure 100 is wrapped by a cladding layer 230. The heating structure 100 includes a sensing region 150 disposed on a side of the substrate layer 110 where no heating wire 120 is disposed. A sensing layer 170 is disposed on the outer side of the sensing region 150 in such a manner that they are separated by a spacer layer 160. Optionally, a foamed structure 240 is further disposed between the heating structure 100 and the cladding layer 230. Here, FIG. 24 shows a sectional structural view taken along the direction B-B showing a steering wheel provided with only one sensing region. FIG. 25 shows a front-side or back-side sectional structural view of a steering wheel provided with two sensing regions. FIG. 25 shows a front-side sectional structural view of a steering wheel provided with three sensing regions, and FIG. 26 shows a back-side sectional structural view of the steering wheel provided with three sensing regions.

In addition, it should be noted that the cladding layer 230 may be made of a material such as leather or leatherette.

It should be noted that, in order to provide a clearer illustration of the layered connection structure of the constituent layers of the steering wheel, in the foregoing embodiments, each of FIGS. 21 to 26 is a sectional structural view formed by sectioning the structure of the steering wheel layer by layer from a middle section of the rim perpendicular to the axial direction of the steering wheel toward the direction of the cladding layer of the steering wheel.

The above description is merely illustrative of preferred embodiments of the present disclosure and illustrative of the utilized technical principles. It should be understood by those skilled in the art that the scope of the invention involved in the present disclosure is not limited to the technical solutions formed by specific combinations of the foregoing technical features, and should also encompass other technical solutions formed by any combinations of the foregoing technical features or their equivalents without departing from the inventive concept, e.g., technical solutions formed by replacing the foregoing features with the technical features having similar functions disclosed in (but not limited to) the present disclosure or vice versa.

### Industrial Applicability

In summary, the present disclosure provides a heating structure and a steering wheel, which can be processed conveniently and produced with high efficiency.

1. A heating structure, comprising a substrate layer, further comprising: a heating wire paved fixedly to the substrate layer by an adhesive, wherein the heating wire is provided with multiple bent portions, each of the bent portions is in a shape formed by squeezing and bending the heating wire; and the heating structure is configured to be arranged between a rim and an outer skin of a steering wheel.

2. The heating structure according to claim 1, wherein a shape of the bent portion is any one of a sawtooth shape, a triangle shape, a V shape, a U shape, a square shape, an S shape, and a trapezoid shape.

3. The heating structure according to claim 1, wherein the heating wire is in a meandering shape in its extending direction.

4. The heating structure according to claim 1, wherein an adhesive layer is disposed on either single side of the substrate layer, or adhesive layers are disposed on both sides of the substrate layer,
wherein the heating wire is glued fixedly to the substrate layer through the adhesive layer.

5. The heating structure according to claim 4, wherein the adhesive layer is formed integrally with the substrate layer, or the adhesive layer is applied to the substrate layer.

6. The heating structure according to claim 4, wherein the adhesive layer is an adhesive film.

7. The heating structure according to claim 4, wherein the heating structure further comprises a release paper, wherein the release paper is removably disposed on a side of at least one adhesive layer facing away from the substrate layer.

8. The heating structure according to claim 1, wherein the adhesive for fixing the heating wire is distributed as scattered dots between the heating wire and the substrate layer, to form an adhesive dot layer, or is wrapped around at least part of an outer surface of the heating wire, to form an adhesive wrapping layer.

9. The heating structure according to claim 1,
wherein the adhesive is made of any one of a non-setting adhesive, a hot melt adhesive, a UV adhesive, and a self-setting adhesive.

10. The heating structure according to claim 1, wherein a flexible layer is further disposed on a side of the substrate layer where the heating wire is adhered.

11. The heating structure according to claim 10, wherein the flexible layer is made of at least one of non-woven fabric, gauze, leather, leatherette, a foam pad, a plastic film, high-elastic sponge, EPDM, and PVC.

12. The heating structure according to claim 1, wherein a hands-off detection device is disposed on a side of the substrate layer where the heating wire is not disposed.

13. The heating structure according to claim 12, wherein the hands-off detection device comprises a spacer layer and a sensing layer, wherein the spacer layer is disposed adjacently to the substrate layer; and the sensing layer is provided with at least one sensing region.

14. The heating structure according to claim 13, wherein the hands-off detection device further comprises a shielding layer, wherein the shielding layer is disposed on a side of the spacer layer away from the sensing layer.

15. The heating structure according to claim 13, wherein the sensing layer is provided with two sensing regions, wherein a first sensing region of the two sensing regions and a second sensing region of the two sensing regions are disposed on left and right sides of the steering wheel, respectively; or
the sensing layer is provided with three sensing regions, wherein a first sensing region and a second sensing region of the three sensing regions are configured to be disposed on a front side of the steering wheel, and a third sensing region of the three sensing regions is configured to be disposed on a back side of the steering wheel.

16. The heating structure according to claim 12, wherein a flexible layer is disposed on a side of the substrate layer where the hands-off detection device is disposed.

17. A steering wheel, wherein the steering wheel has a rim cladded with the heating structure according to claim 1.

18. The steering wheel according to claim 17, wherein an outer surface of the heating structure is wrapped by a cladding layer.

19. The steering wheel according to claim 18, wherein the cladding layer is an outer skin.

20. The steering wheel according to claim 18, wherein a foamed structure is further disposed between the heating structure and the cladding layer.
